(19) United States
(12) Patent Application Publication
(10) Pub. No.: US 2013/0018634 A1
(43) Pub. Date: Jan. 17, 2013

(54) APPARATUS AND METHOD OF AUTOMATICALLY EXTRACTING SWEEP/EXTRUDE/REVOLVE FEATURE SHAPE FROM ATYPICAL DIGITAL DATA

(71) Applicants: Seock Hoon BAE, Seoul (KR); Dong Hoon LEE, Seoul (KR); Sung Wook CHO, Bucheon (KR); Chang Yoon YANG, Sungnam City (KR); Kang Hoon CHUNG, Seongnam-si (KR)

(72) Inventors: Seock Hoon BAE, Seoul (KR); Dong Hoon LEE, Seoul (KR); Sung Wook CHO, Bucheon (KR); Chang Yoon YANG, Sungnam City (KR); Kang Hoon CHUNG, Seongnam-si (KR)

(73) Assignee: INUS TECHNOLOGY, INC., Seoul (KR)

(21) Appl. No.: 13/323,123

(22) Filed: Dec. 12, 2011

(30) Foreign Application Priority Data
Jul. 13, 2011 (KR) 10-2011-0069305

(51) Int. Cl. G06F 17/50

(52) U.S. Cl. 703/1

(57) ABSTRACT

Provided is an apparatus and method of automatically extracting a sweep/extrude/revolve feature shape from atypical digital data, including a scanner which scans a 3D object so as to provide 3D scan data indicating a shape of the 3D object, and a computing device which extracts a feature shape from a collection of the 3D scan data collected from the scanner, wherein the computing device includes an extracting means for extracting multiple points from the collection of the 3D scan data and producing initial section from the extracted multiple points; an aligning means for aligning the sections so that shapes of the sections are coincided with each other; a compensating means for forming an initial path, generating an initial profile and then compensating the path; and a modeling means for performing a modeling function using the compensated path and profile.

### CROSS-REFERENCE(S) TO RELATED APPLICATIONS

The present invention claims priority of Korean Patent Application No. 10-2011-0069305, filed on Jul. 13, 2011, which is incorporated herein by reference.

### BACKGROUND OF THE INVENTION

1. Field of the Invention

The present invention relates to an apparatus and method of automatically extracting a sweep/extrude/revolve feature shape from atypical digital data, and particularly to an apparatus and method of automatically extracting sweep/extrude/revolve feature shape from atypical digital data, in which path and profile extracted according to a particular criterion are repeatedly renewed into an average shape of aligned sections, and the average shape is moved along the path so as to produce a final shape, thereby optimizing the extracted path and profile, and thus a reverse model can be rapidly and precisely produced from three dimensional (3D) scan data without an existing manual work or measuring operation.

2. Description of Related Art

Generally, a digital model such as a 3D CAD model of a component is definitely needed in operating a digital production system using CAD/CAM/CAE. Particularly, shape measurement with respect to handmade prototypes, old products, competing products, human body and the like represent the areas that replication works using reverse engineering technology are typically utilized.

Reverse engineering is a process that extracts feature shapes from 3D scan data as raw data, which can be defined as a mathematically defined surface shape or a change in a parameter, and allows the extracted feature shapes to be efficiently reused in other CAD or production site.

In the reverse engineering process, when the 3D scan data obtained by a 3D scanner is loaded on a screen, the raw data consists of pieces of information called shape appearance or boundary representation. However, since the raw data is not a feature shape having a meaning, it is necessary to use recognition capacity and estimation of the user in order to form data used in other applications from the raw data.

In this case, it takes considerable time and effort. Further, since the measurements of the 3D scanning are not exactly reflected in the result, other problems may occur.

Solutions of shapes(e.g., cylinder, sphere) which are mathematically defined by data-fitting the raw data obtained from the 3D scanning are generally known and used in various industrial fields.

In case that a trace of a section plane is formed into a linear or arc shape, or the section plane has a simple shape, it is possible to perform the data fitting. However, in case of an extrusion, revolve shape of which the mathematical shape is expressed by an atypical section, or in case that a free form curve is a sweep shape, the user typically selects a proper section and performs modeling of a CAD feature so as to manually control various parameters, thereby undergoing many trials and errors. Therefore, although it is possible to obtain a desired shape, it takes long time for the many trials and errors. Furthermore, it is difficult to find an analytic shape among the obtained shapes within the margin of error.

### SUMMARY OF THE INVENTION

An embodiment of the present invention is directed to providing an apparatus and method of automatically extracting a sweep/extrude/revolve feature shape from atypical digital data, which can rapidly and precisely extract a feature shape having a high degree of freedom, thereby reducing the time and effort.

To achieve the object of the present invention, the present invention provides a method of automatically extracting a sweep/extrude/revolve feature shape from atypical digital data, including providing a collection of 3D scan data indicating a shape of a 3D object by scanning the 3D object; extracting multiple points from the collection of the 3D scan data and generating initial sections from the extracted multiple points; aligning the sections so as to be coincided with each other; forming an initial path and an initial profile and then compensating the path; and performing a modeling process using the compensated path and profile.

Preferably, in the forming of the initial path and profile and the compensating of the path, local coordinates are extracted from the aligned sections and the initial path is formed by connecting the coordinates.

Preferably, in the forming of the initial path and profile and the compensating of the path, points spaced apart at regular intervals are obtained from the initial path, and the sections are re-extracted from the points, and then an average shape of the sections is extracted so as to generate an initial profile.

Preferably, in the forming of the initial path and profile and the compensating of the path, the re-extracted sections are aligned again, and the same local coordinates are grasped so as to compensate the initial path.

Preferably, the method further includes repeatedly performing the extracting of the multiple points from the collection of the 3D scan data and the generating of the initial sections from the extracted multiple points, the aligning of the sections to be coincided with each other, and the forming of the initial path and profile and the compensating of the path, in order to continuously renew the profile and path until a result thereof arrives at a predetermined condition. Preferably, in the repeatedly performing of the extracting of the multiple points from the collection of the 3D scan data and the generating of the initial sections from the extracted multiple points, the aligning of the sections to be coincided with each other, and the forming of the initial path and profile and the compensating of the path, the renewed path and profile are fed back as an input value from a second iterating process.

Preferably, the modeling process is at least one of sweeping, extruding and revolving.

Preferably, in the extracting of the multiple points from the collection of the 3D scan data and the generating of the initial sections from the extracted multiple points, sampling of the points on the input shape is performed according to a particular criterion which allows a portion having a remarkable curvature to be included, and then sections planes which are substantially vertically passed through peripheral shapes of the sampled points are extracted.

Preferably, in the forming of the initial path and profile and the compensating of the path, the profile is renewed an average shape calculated from the aligned sections, and the path is renewed by extracting the same coordinates of the aligned sections.

Further, the present invention provides an apparatus for automatically extracting a sweep/extrude/revolve feature shape from atypical digital data, including a scanner which scans a 3D object so as to provide 3D scan data indicating a shape of the 3D object, and a computing device which extracts a feature shape from a collection of the 3D scan data collected from the scanner, wherein the computing device includes an extracting means for extracting multiple points from the collection of the 3D scan data and producing initial section from the extracted multiple points; an aligning means for aligning the sections so that shapes of the sections are coincided with each other; a compensating means for forming an initial path, generating an initial profile and then compensating the path; and a modeling means for performing a modeling function using the compensated path and profile.

Preferably, the compensating means extracts local coordinates from the aligned initial sections and forms an initial path connecting the local coordinates.

Preferably, the compensating means obtains points spaced apart at regular intervals from the initial path, re-extracts again the sections from the points and then obtains an average shape of the sections so as to generate an initial profile.

Preferably, the compensating means aligns again the re-extracted sections so as to grasp the same local coordinates, and then compensates the initial path.

Preferably, the computing device further includes an iterating means for repeatedly performing functions of the extracting means, the aligning means and the compensating means until a result thereof arrives at a predetermined condition. Preferably, the iterating means feeds back the renewed path as an input value from a second iterating process.

Preferably, the modeling means performs at least one of sweeping, extruding and revolving functions.

Preferably, the extracting means performs sampling of the points on the input shape according to a particular criterion which allows a portion having a remarkable curvature to be included, and extracts sections which are substantially vertically passed through peripheral shapes of the sampled points.

Preferably, the compensating means renews the profile into the average shape calculated from the aligned sections, and extracts the same coordinates of the aligned sections so as to renew the path.

### BRIEF DESCRIPTION OF THE DRAWINGS

FIG. 1 is a schematic block diagram showing a configuration of an apparatus for automatically extracting a sweep/extrude/revolve feature shape from atypical digital data according to the present invention.

FIG. 2 is a schematic flow chart showing a method of automatically extracting a sweep/extrude/revolve feature shape from atypical digital data according to the present invention.

FIG. 3 is a flow chart showing a method of automatically extracting a sweep/extrude/revolve feature shape from atypical digital data according to an embodiment of the present invention, in which a sweep wizard is performed.

FIG. 4 is a flow chart showing a method of automatically extracting a sweep/extrude/revolve feature shape from atypical digital data according to an embodiment of the present invention, in which an extrude wizard is performed.

FIG. 5 is a flow chart showing a method of automatically extracting a sweep/extrude/revolve feature shape from atypical digital data according to an embodiment of the present invention, in which a revolve wizard is performed.

FIGS. 6a to 6c are views for explaining the sweep wizard.

[Detailed Description of Main Elements]

| | |
|---|---|
| 100: computing device | 110: extracting means |
| 120: aligning means | 130: compensating means |
| 140: modeling means | 200: 3D scanner |
| 300: display | |

### DESCRIPTION OF SPECIFIC EMBODIMENTS

The advantages, features and aspects of the invention will become apparent from the following description of the embodiments with reference to the accompanying drawings, which is set forth hereinafter.

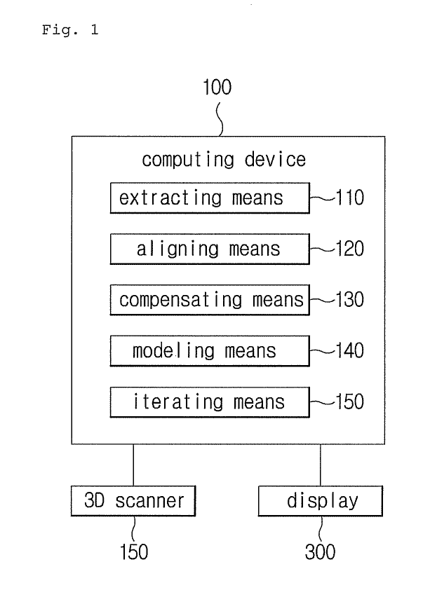

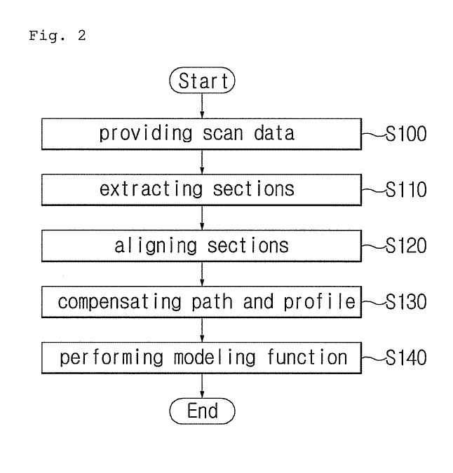

FIG. 1 is a schematic block diagram showing a configuration of an apparatus for automatically extracting a sweep/extrude/revolve feature shape from atypical digital data according to the present invention, and FIG. 2 is a schematic flow chart showing a method of automatically extracting a sweep/extrude/revolve feature shape from atypical digital data according to the present invention. As shown in the drawings, an apparatus for automatically extracting a sweep/extrude/revolve feature shape from atypical digital data according to the present invention includes a computing device 100 having an extracting means 110, an aligning means 120, a compensating means 130 and a modeling means 140, and a 3D scanner 200. The apparatus carries out processes shown in FIG. 2 through the means or the computing device.

The 3D scanner 200 communicates with the computing device 100, scans a 3D object so as to produce the 3D scan data indicating a shape of the 3D object, and provides a collection of the 3D scan data to the computing device 100 (S100).

Herein, the 3D scan data is collected from the 3D scanner 200 communicating with the computing device 100 or a collection of previously stored scan data. The 3D scan data as raw data collected through the 3D scanner 200 may be a point group, a triangular mesh, a rectangular mesh, a tetrahedral mesh or a hexahedral mesh.

The computing device 100 functions as a host of the extracting means 110, the aligning means 120, the compensating means 130 and the modeling means 140. Further, the computing device 100 may be a workstation, a server, a laptop, a mainframe, a PDA, a cluster for devices co-operated with each other, a virtual device, or other computing device.

The extracting means 110 extracts multiple points from the collection of the 3D scan data collected through the 3D scanner 200 or the input shapes, and then produces initial section planes from the extracted multiple points (S110).

Herein, the extracting means 110 performs sampling of the points on the input shape according to a particular criterion which allows a portion having a remarkable curvature of the collection of the 3D scan data or the input shapes to be included, and then extracts sections which are substantially vertically passed through peripheral shapes of the sampled points.

Meanwhile, the computing device 100 determines whether there is a path in the information input by the user. If it is determined that there is not a path, curvature information of the 3D object is calculated from the shape information of the 3D scan data, and a section plane which is vertical to a shape of the 3D object is extracted from the points of which the curvature exceeds a desired reference and then used as input information in the data fitting process. Such a calculating process is correspondent to the process of extracting the section through the sampling of the path.

The aligning means 120 functions to align the multiple sections extracted from the extracting means 110 (S120).

If the extracted sections are aligned, a difference in the shapes of the sections is generated according to certain points. The difference in the shapes of the sections is compensated by the compensating means 130.

The compensating means 130 forms an initial path and compensates the path after generating an initial profile (S130). More detailedly, the compensating means 130 extracts local coordinates from the sections aligned through the aligning means 120 and then forms the initial path connecting the coordinates.

Further, the compensating means 130 obtains points spaced apart at regular intervals from the initial path, re-extracts again the sections from the points and then obtains an average shape of the sections so as to generate an initial profile. And the compensating means 130 aligns again the re-extracted sections so as to grasp the same local coordinates, and then compensates again the initial path.

That is, the compensating means 130 calculates an average shape of the aligned sections, and then compensates the shape of the section extracted through the extracting means 110 using the calculated average shape of the sections.

Herein, the compensating of the profile is to renew the average section of the aligned sections into a profile, and the compensating of the path is to extract a center point of the aligned sections and renew the path. That is, in the compensating of the path, a new center point is extracted by comparing the center point of each section and the center point of the aligned sections, thereby renewing the path.

Meanwhile, the computing device 100 further includes an iterating means 150 for adapting the extracting means 110, the aligning means 120 and the compensating means 130 to iterate the extracting, aligning and compensating of the profile and path, thereby gradually optimizing the extracted path and profile. That is, the iterating means 150 uses the profile and path in the previous iterating process as an input value in the next iterating process, thereby producing an optimized path and profile. In other words, the iterating means 150 adapts the extracting means 110, the aligning means 120 and the compensating means 130 to repeatedly perform their own functions until a result thereof arrives at a desired condition. Herein, the renewed path and profile are used as the input value from the second iterating process, i.e. fed back.

The modeling means 140 performs the modeling process using the path and profile compensated or renewed through the compensating means 140 (S140). Herein, the modeling function performed in the modeling means 140 is at least one of sweeping, extruding and revolving.

Further, in the modeling means 140, the modeling process may be performed by decomposing a produce having a free-form curve, which is obtained in the form of an analytic shape within the proper margin of error. In other words, the modeling process may be performed by converting the free-from curve or a part thereof into a combination of a straight line and an arc.

Meanwhile, a reverse engineering model generated by the modeling means 140 may be displayed through a display 300.

As described above, in the apparatus for automatically extracting the feature shape from atypical digital data according to the present invention, since the modeling process is performed in the state that the extracted path and profile are renewed into the average shape of the aligned sections, it is possible to rapidly and precisely produce the reverse engineering model from the 3D scan data without performing the existing manual work or measuring operation, when extracting the feature shape of the object having a high degree of freedom.

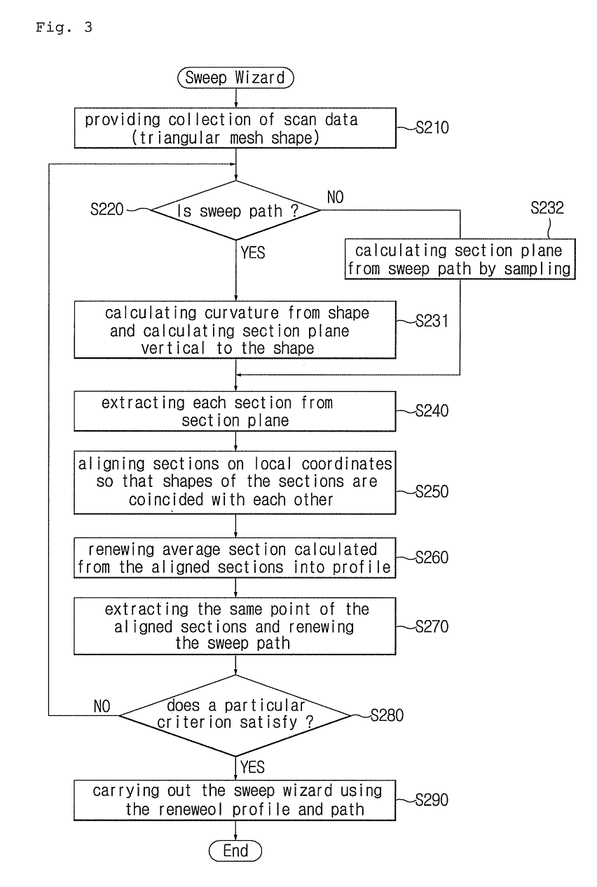

FIGS. 3 to 5 are flow charts schematically showing the method of automatically extracting the feature shape from atypical digital data according to the present invention.

FIG. 3 is a flow chart showing a method of automatically extracting a sweep/extrude/revolve feature shape from atypical digital data according to an embodiment of the present invention, in which a sweep wizard is performed.

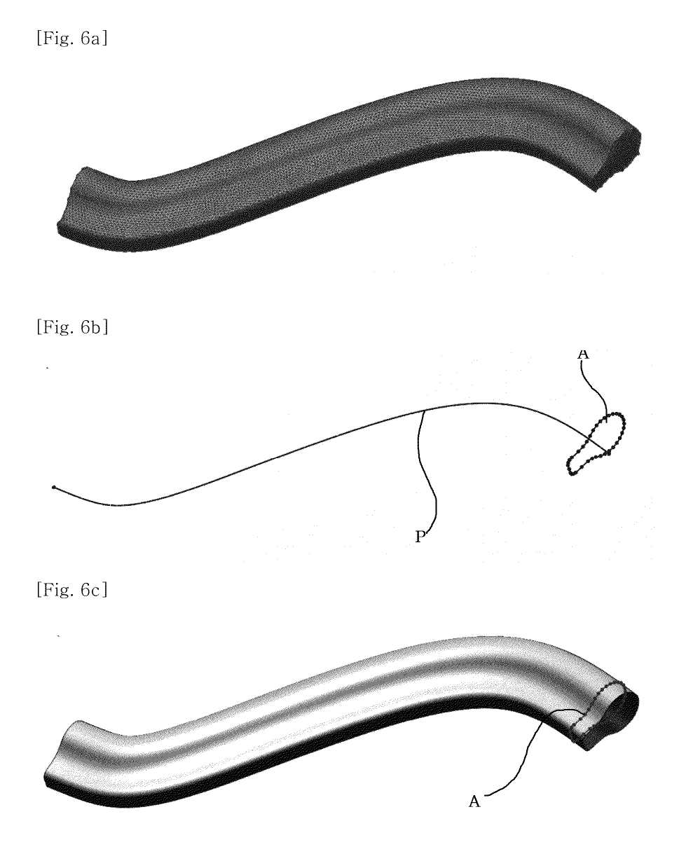

Herein, the sweep wizard is one of designing functions used in designing programs, and will be described with reference to FIGS. 6a to 6c.

In case that the scanned shape or the input shape has a high degree of freedom as shown in FIG. 6a, a path P is set and points forming a section plane are extracted so as to generate the section plane A, as shown in FIG. 6b, and then the section plane A is moved along the set path P, thereby obtaining a modeling shape shown in FIG. 6c.

That is, the sweep wizard is to generate feature of a shape along a path.

If the sweep wizard is carried out, the collection of the 3D scan data collected through the 3D scanner 200 is provided to the computing device 100 (S210), the data is formed into a triangular mesh. Then, the extracting means 110 determines whether a sweep path exists in the collection of the 3D scan data (S220). As the result, if the sweep path exists, the extracting means 110 samples the sweep path and calculates a section plane (S231). However, if the sweep path does not exists, the extracting means 110 calculates curvature information of the 3D object using shape information of the provided 3D scan data and then calculates a section plane which is vertical to the 3D object (S232).

And the extracting means 110 extracts each section from the calculated section plane (S240). Then, the aligning means 120 aligns the extracted sections on a local coordinate so that the extracted sections are coincided with each other (S250).

After the extracted sections are completely aligned, the compensating means 130 calculates an average section from the aligned sections and renews a sweep profile using the calculated average section (S260). Further, compensating means 130 extracts a concentric center, i.e., a center point of the aligned sections and renews the sweep path (S270). That is, in the compensating of the sweep path, the center point of each section is compared with the center point of the aligned sections so as to extract a new center point, thereby renewing the sweep path. The renewing process is repeatedly performed by the iterating means 150 until the sweep path is optimized according to a particular criterion.

Then, the computing device 100 determines whether each of the processes satisfies its own criterion (S280). That is, it is determined whether a difference between the renewed path and the input shape and a reduction of a change rate in the iterating process satisfy a particular criterion.

If they satisfy the particular criterion, the modeling means 140 carries out the sweep wizard using the renewed profile and path (S290).

Therefore, even in case that the sweep wizard having a high degree of freedom is performed, the modeling is carried out in the state that the profile and path are compensated to be close to a shape of an actual object, and thus it is possible to precisely perform the modeling without manually controlling various parameters and undergoing trials and errors.

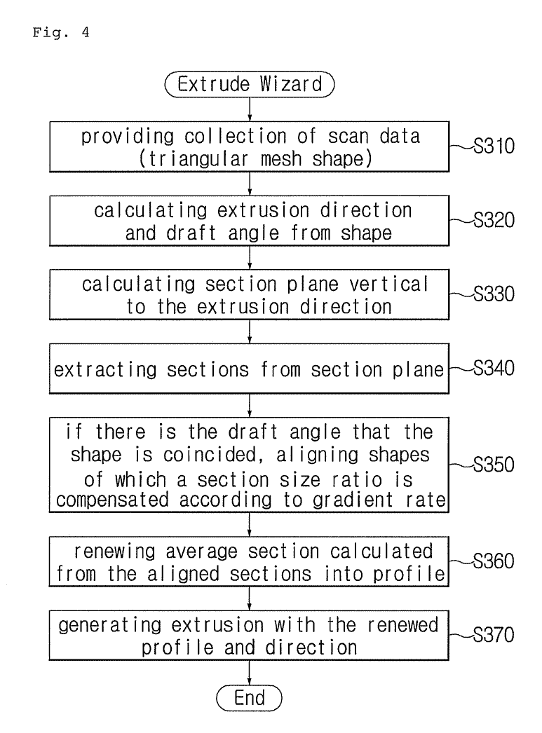

FIG. 4 is a flow chart showing a method of automatically extracting a sweep/extrude/revolve feature shape from atypical digital data according to an embodiment of the present invention, in which an extrude wizard is performed.

If the extrude wizard is performed, the collection of the 3D scan data is provided to the computing device (S310), and the 3D scan data is formed into the triangular mesh. Then, the extracting means 110 calculates an extrusion direction and a draft angle of the object on the basis of the shape information obtained from the collection of the 3D scan data provided to the computing device 100 (S320), and calculates the section plane vertical to the extrusion direction over an area of the shape (S330), and then extracts the section from the calculated section plane (S340).

Then, the aligning means 120 aligns the extracted sections based on a local coordinate so that the extracted sections are coincided with each other (S350). Herein, if there is the draft angle that the shape is coincided, the aligning means 120 aligns the shapes of which a section size ratio is compensated according to a gradient rate.

If the alignment of the extracted sections is completed, the compensating means 130 calculates an average section from the aligned sections, and then renews the extrusion profile using the average section (S360).

Next, the modeling means 140 carries out the extrude wizard using the renewed profile and direction and models a 3D object (S370).

Therefore, even in case that the extrude wizard having a high degree of freedom is performed, the modeling is carried out in the state that the profile and direction are compensated to be close to a shape of an actual object, and thus it is possible to precisely perform the modeling without manually controlling various parameters and undergoing trials and errors.

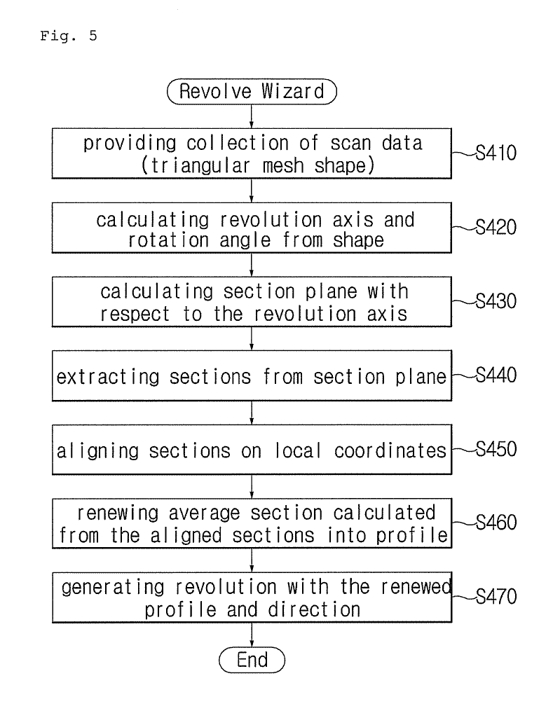

FIG. 5 is a flow chart showing a method of automatically extracting a sweep/extrude/revolve feature shape from atypical digital data according to an embodiment of the present invention, in which a revolve wizard is performed.

If the revolve wizard is performed, the collection of the 3D scan data is provided to the computing device 100 (S410), and the 3D scan data is formed into the triangular mesh. Then, the extracting means 110 calculates a revolution axis and a rotation angle of the object on the basis of the shape information obtained from the collection of the 3D scan data provided to the computing device 100 (S420), and calculates the section plane vertical to the revolution axis over an area of the shape (S430), and then extracts the section from the calculated section plane (S440).

Then, the aligning means 120 aligns the extracted sections based on a local coordinate (S450).

If the alignment of the extracted sections is completed, the compensating means 130 calculates an average section from the aligned sections, and then renews the revolve profile using the average section (S460).

After that, the modeling means 140 carries out the revolution wizard using the renewed profile and revolution, and models a 3D object (S470).

Therefore, even in case that the revolve wizard having a high degree of freedom is performed, the modeling is carried out in the state that the profile, revolution axis and rotation angle are compensated to be close to a shape of an actual object, and thus it is possible to precisely perform the modeling without manually controlling various parameters and undergoing trials and errors.

According to the present invention, since the extracted path and profile are renewed into an average shape of the aligned sections, it is possible to rapidly and precisely produce the reverse engineering model from the 3D scan data without the existing manual work or measuring operation.

While the present invention has been described with respect to the specific embodiments, it will be apparent to those skilled in the art that various changes and modifications may be made without departing from the spirit and scope of the invention as defined in the following claims.

What is claimed is:

1. A method of automatically extracting a sweep/extrude/revolve feature shape from atypical digital data, comprising:
providing a collection of 3D scan data indicating a shape of a 3D object by scanning the 3D object;
extracting multiple points from the collection of the 3D scan data and generating initial sections from the extracted multiple points;
aligning the sections so as to be coincided with each other;
forming an initial path and an initial profile and then compensating the path; and
performing a modeling process using the compensated path and profile.

2. The method of claim 1, wherein, in the forming of the initial path and profile and the compensating of the path, local coordinates are extracted from the aligned sections and the initial path is formed by connecting the coordinates.

3. The method of claim 2, wherein, in the forming of the initial path and profile and the compensating of the path, points spaced apart at regular intervals are obtained from the initial path, and the sections are re-extracted from the points, and then an average shape of the sections is extracted so as to generate an initial profile.

4. The method of claim 3, wherein, in the forming of the initial path and profile and the compensating of the path, the re-extracted sections are aligned again, and the same local coordinates are grasped again so as to compensate the initial path.

5. The method of claim 4, further comprising:
repeatedly performing the extracting of the multiple points from the collection of the 3D scan data and the generating of the initial sections from the extracted multiple points, the aligning of the sections to be coincided with each other, and the forming of the initial path and profile and the compensating of the path, in order to continuously renew the profile and path until a result thereof arrives at a predetermined condition.

6. The method of claim 5, wherein, in the repeatedly performing of the extracting of the multiple points from the collection of the 3D scan data and the generating of the initial sections from the extracted multiple points, the aligning of the sections to be coincided with each other, and the forming of the initial path and profile and the compensating of the path, the renewed path and profile are fed back as an input value from a second iterating process.

7. The method of claim 1, wherein the modeling process is at least one of sweeping, extruding and revolving.

8. The method of claim 1, wherein, in the extracting of the multiple points from the collection of the 3D scan data and the generating of the initial sections from the extracted multiple points, sampling of the points on the input shape is performed according to a particular criterion which allows a portion having a remarkable curvature to be included, and then sections planes which are substantially vertically passed through peripheral shapes of the sampled points are extracted.

9. The method of claim 1, wherein, in the forming of the initial path and profile and the compensating of the path, the profile is renewed an average shape calculated from the aligned sections, and the path is renewed by extracting the same coordinates of the aligned sections.

10. An apparatus for automatically extracting a sweep/extrude/revolve feature shape from atypical digital data, comprising:
a scanner which scans a 3D object so as to provide 3D scan data indicating a shape of the 3D object, and
a computing device which extracts a feature shape from a collection of the 3D scan data collected from the scanner,
wherein the computing device comprises:
an extracting means for extracting multiple points from the collection of the 3D scan data and producing initial section from the extracted multiple points;
an aligning means for aligning the sections so that shapes of the sections are coincided with each other;
a compensating means for forming an initial path, generating an initial profile and then compensating the path; and
a modeling means for performing a modeling function using the compensated path and profile.

11. The apparatus of claim 10, wherein the compensating means extracts local coordinates from the aligned initial sections and forms an initial path connecting the coordinates.

12. The apparatus of claim 11, wherein the compensating means obtains points spaced apart at regular intervals from the initial path, re-extracts again the sections from the points and then obtains an average shape of the sections so as to generate an initial profile.

13. The apparatus of claim 12, wherein the compensating means aligns again the re-extracted sections so as to grasp the same local coordinates, and then compensates the initial path.

14. The apparatus of claim 13, wherein the computing device further comprises an iterating means for repeatedly performing functions of the extracting means, the aligning means and the compensating means until a result thereof arrives at a desired condition.

15. The apparatus of claim 14, wherein the iterating means feeds back the renewed path as an input value from a second iterating process.

16. The apparatus of claim 10, wherein the modeling means performs at least one of sweeping, extruding and revolving functions.

17. The apparatus of claim 10, wherein the extracting means performs sampling of the points on the input shape according to a particular criterion which allows a portion having a remarkable curvature to be included, and extracts sections which are substantially vertically passed through peripheral shapes of the sampled points.

18. The apparatus of claim 10, wherein the compensating means renews the profile into the average shape calculated from the aligned sections, and extracts the same coordinates of the aligned sections so as to renew the path.
